(19) United States
(12) Patent Application Publication
(10) Pub. No.: US 2007/0198304 A1
(43) Pub. Date: Aug. 23, 2007

(54) SYSTEM FOR ONLINE TRAVEL PLANNING

(76) Inventors: Elliot Joseph Cohen, Raanana (IL); Yotam Luz, Burgata (IL); Hiza Peleg, Tez Aviv (IL)

Correspondence Address: KEVIN CHEN, 4245 SHOREPOINTE WAY, SAN DIEGO, CA, 92130, US

(21) Appl. No.: 11/623,323

(22) Filed: Jan. 16, 2007

Related U.S. Application Data
(60) Provisional application No. 60/766,383, filed on Jan. 16, 2006.

(51) Int. Cl. G06Q 10/00

(52) U.S. Cl. 705/5

(57) ABSTRACT

A method for travel planning employing a computerized database query system, the method including user designation of at least one desired travel parameter and system presentation to user of at least one proposed travel region, based on the user designation, the at least one proposed travel region having geographical boundaries which are generally independent of political boundaries.

### REFERENCE TO RELATED APPLICATIONS

Reference is made to U.S. Provisional Patent Application Ser. No. 60/766,383, filed Jan. 16, 2006 and entitled System for Online Travel Planning, the disclosure of which is hereby incorporated by reference and priority of which are hereby claimed pursuant to 37 CFR 1.78(a) (4) and (5)(i).

### FIELD OF THE INVENTION

The present invention relates generally to systems and methodologies for interactive travel planning and more particularly to computer-network based systems and methodologies for travel planning as well as computer-based methods and apparatus for creating such systems and methodologies.

### BACKGROUND OF THE INVENTION

The following U.S. Patent Publications, the disclosures of which are hereby incorporated by reference, are believed to represent the current state of the art:

U.S. Pat. Nos. 6,282,489; 6,993,430; 6,801,226 and 6,295,521; and

U.S. Patent Application Publication Nos. 2006/0271277; 2006/0287810; 2005/0021424 and 2005/0216301.

### SUMMARY OF THE INVENTION

The present invention seeks to provide improved computer-network based systems and methodologies for travel planning as well as computer-based methods and apparatus for creating such systems and methodologies.

There is thus provided in accordance with a preferred embodiment of the present invention a method for travel planning employing a computerized database query system, the method including user designation of at least one desired travel parameter and system presentation to user of at least one proposed travel region, based on the user designation, the at least one proposed travel region having geographical boundaries which are generally independent of political boundaries.

In accordance with a preferred embodiment of the present invention the method also includes system presentation to user of a visually sensible graphical map of the at least one proposed travel region bearing visually sensible indicia corresponding to proposed travel locations within the at least one proposed travel region corresponding to the at least one desired travel parameter. Preferably, the method also includes user designation of user-selected ones of the visually sensible indicia and system collection of travel locations corresponding to the user-selected ones of the visually sensible indicia.

In accordance with another preferred embodiment of the present invention the method also includes system generation of a proposed travel itinerary based at least partially on the user-selected ones of the visually sensible indicia.

In accordance with yet another preferred embodiment of the present invention the at least one desired travel parameter includes a type of user activity. Preferably, the at least one desired travel parameter includes a type of user interest. Additionally or alternatively, the geographical boundaries of the at least one proposed travel region are selected at least partially by the extent of presence within the geographical boundaries of user selectable proposed travel locations.

In accordance with still another preferred embodiment of the present invention the at least one proposed travel region has geographical boundaries which are determined at least in part by the at least one desired travel parameter designated by the user. Preferably, the at least one desired travel parameter is selected by the user from a prepared set of possible desired travel parameters available for designation by the user.

In accordance with a further preferred embodiment of the present invention the geographical boundaries of the at least one proposed travel region are pre-determined for plural ones of the possible desired travel parameters available for designation by the user. Preferably, the geographical boundaries of the at least one proposed travel region are generated in response to designation of the at least one desired travel parameter by the user.

There is also provided in accordance with another preferred embodiment of the present invention a system for travel planning including a graphical user interface operative to enable user designation of at least one desired travel parameter, an interactive computer system responsive to the user designation for selecting at least one proposed travel region, the geographical boundaries of the at least one proposed travel region being generally independent of political boundaries and a display presenting to the user in visually sensible form the at least one proposed travel region.

In accordance with a preferred embodiment of the present invention the interactive computer system and the display are operative to provide to the user a visually sensible graphical map of the at least one proposed travel region bearing visually sensible indicia corresponding to proposed travel locations within the at least one proposed travel region corresponding to the at least one desired travel parameter. Preferably, the graphical user interface is also operative for user designation of user-selected ones of the visually sensible indicia and the interactive computer system includes functionality for collection of travel locations corresponding to the user-selected ones of the visually sensible indicia.

In accordance with another preferred embodiment of the present invention the interactive computer system includes functionality for generation of a proposed travel itinerary based at least partially on the user-selected ones of the visually sensible indicia. Preferably, the at least one desired travel parameter includes a type of user activity. Alternatively, the at least one desired travel parameter includes a type of user interest.

In accordance with yet another preferred embodiment of the present invention the geographical boundaries of the at least one proposed travel region are selected at least partially by the extent of presence within the geographical boundaries of user selectable proposed travel locations. Preferably, the at least one proposed travel region has geographical boundaries which are determined by the interactive computer system at least in part by the at least one desired travel parameter designated by the user.

In accordance with still another preferred embodiment of the present invention the at least one desired travel parameter is selected by the user from a prepared set of possible desired travel parameters available for designation by the user. Preferably, the geographical boundaries of the at least one proposed travel region are pre-determined for plural ones of the possible desired travel parameters available for designation by the user. Additionally or alternatively, the geographical boundaries of the at least one proposed travel region are generated by the interactive computer system in response to designation of the at least one desired travel parameter by the user.

There is further provided in accordance with a further preferred embodiment of the present invention a method for constructing a system for travel planning including a graphical user interface operative to enable user designation of at least one desired travel parameter, an interactive computer system responsive to the user designations for selecting at least one proposed travel region and a display presenting to the user in visually sensible form the at least one proposed travel region, the method including designating a plurality of desired travel parameters, for the plurality of desired travel parameters selecting a multiplicity of proposed travel locations corresponding thereto, selecting the geographical boundaries of a plurality of the proposed travel regions independently of political boundaries and preparing information relating at least one of the plurality of proposed travel regions for presentation to the user on the display in visually sensible form.

In accordance with a preferred embodiment of the present invention the method also includes preparing information relating at least to a visually sensible graphical map of the at least one proposed travel region bearing visually sensible indicia corresponding to proposed travel locations within the at least one proposed travel region corresponding to the at least one desired travel parameter for presentation to the user on the display in visually sensible form. Preferably, the method also includes configuring the graphical user interface for user designation of user-selected ones of the visually sensible indicia and configuring the interactive computer system for collection of travel locations corresponding to the user-selected ones of the visually sensible indicia.

In accordance with another preferred embodiment of the present invention the method also includes configuring the interactive computer system for generation of a proposed travel itinerary based at least partially on the user-selected ones of the visually sensible indicia. Preferably, the at least one desired travel parameter includes a type of user activity. Alternatively, the at least one desired travel parameter includes a type of user interest.

In accordance with yet another preferred embodiment of the present invention the selecting the geographical boundaries of the at least one proposed travel region includes selection of the geographical boundaries at least partially by the extent of presence within the geographical boundaries of user selectable proposed travel locations. Preferably, the selecting the geographical boundaries of the at least one proposed travel region includes constructing an interactive functionality operative to enable automatic selection of the geographical boundaries at least partially in accordance with the extent of presence within the geographical boundaries of proposed travel locations corresponding to the at least one desired travel parameter designated by the user.

In accordance with still another preferred embodiment of the present invention the interactive functionality enables the at least one desired travel parameter to be selected by the user from a prepared set of possible desired travel parameters available for designation by the user. Alternatively, the interactive functionality employs pre-determined geographical boundaries of the at least one proposed travel region corresponding to plural ones of the possible desired travel parameters available for designation by the user. As a further alternative, the interactive functionality enables the geographical boundaries of the at least one proposed travel region to be generated in response to designation of the at least one desired travel parameter by the user.

### BRIEF DESCRIPTION OF THE DRAWINGS

The present invention will be understood and appreciated more fully from the following detailed description, taken in conjunction with the drawings in which:

FIGS. 1A-1G are together a simplified illustration of the operation of a preferred embodiment of the present invention;

FIG. 2 is a simplified flow chart illustrating operation of preferred embodiments of the present invention;

FIGS. 3A-3G are exemplary screen shots illustrating a computer screen as seen by a user at various stages of operation of the present invention;

FIGS. 4A-4I are exemplary screen shots illustrating a computer screen as seen by a user at various further stages of operation of the present invention;

FIGS. 5A-5F are exemplary screen shots illustrating a computer screen as seen by a user at various additional stages of operation of the present invention; and

FIG. 6 is a simplified illustrative diagram of an algorithm employed in accordance with one embodiment of the present invention.

### DETAILED DESCRIPTION OF A PREFERRED EMBODIMENT

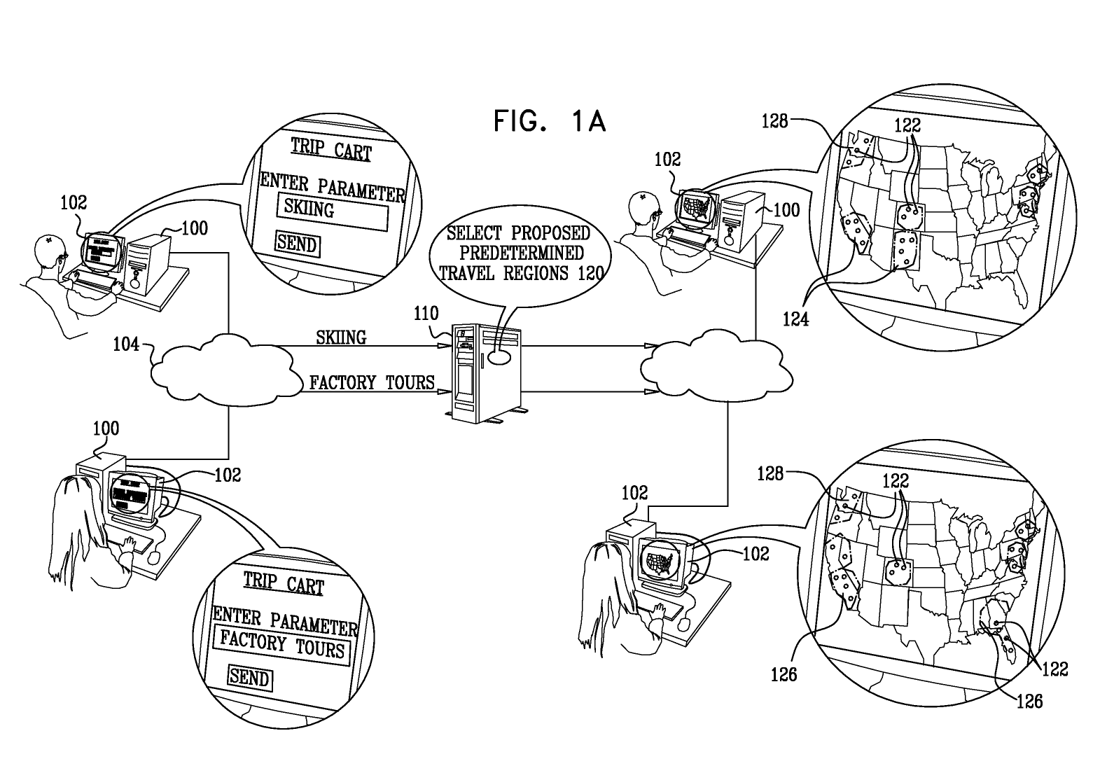

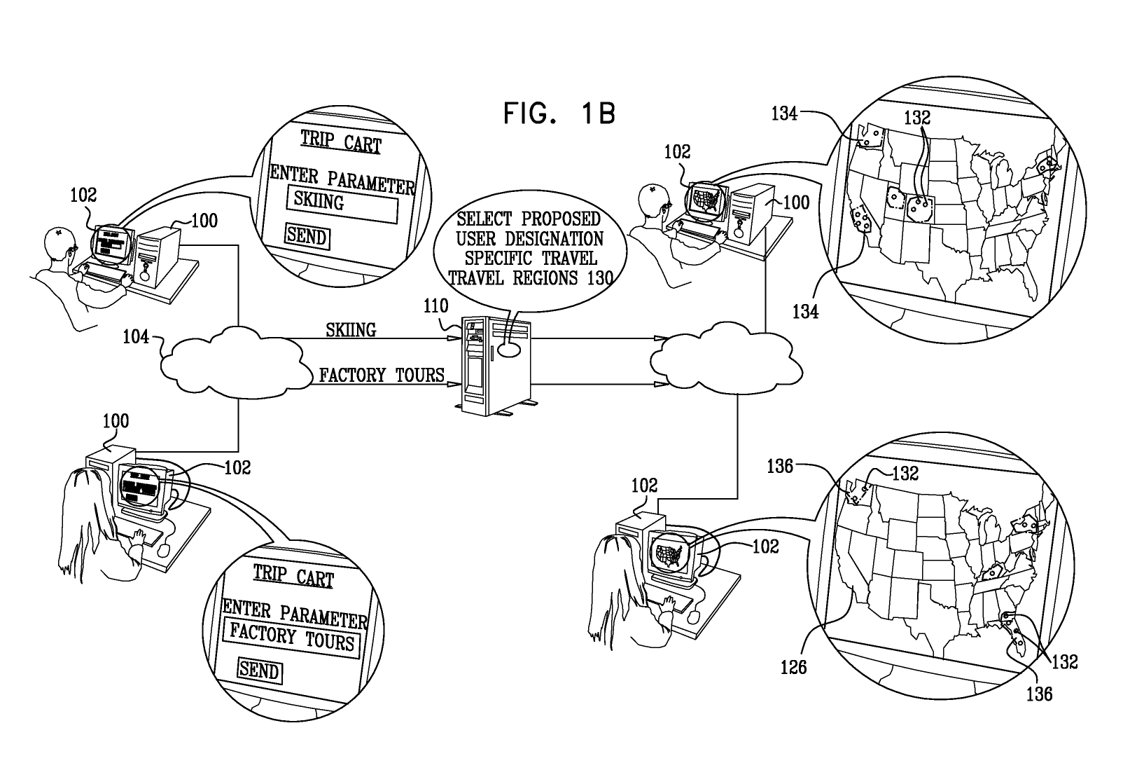

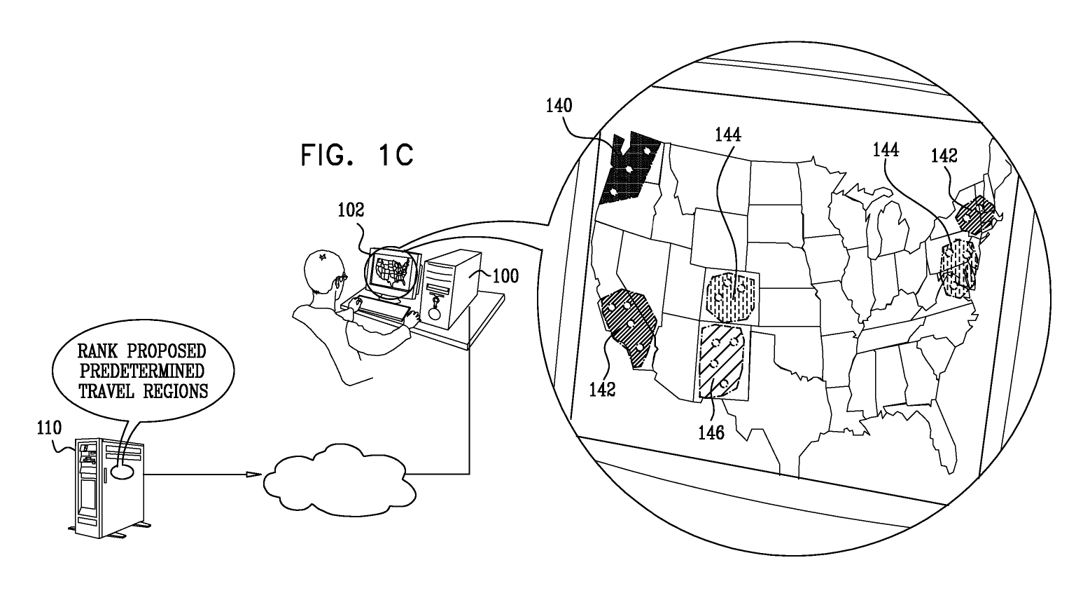

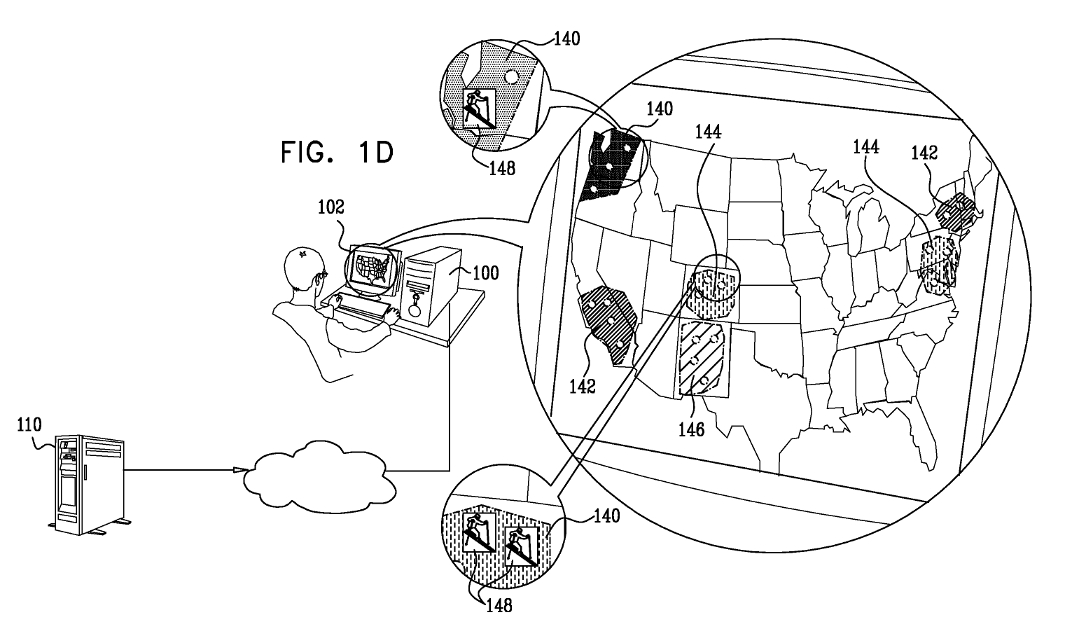

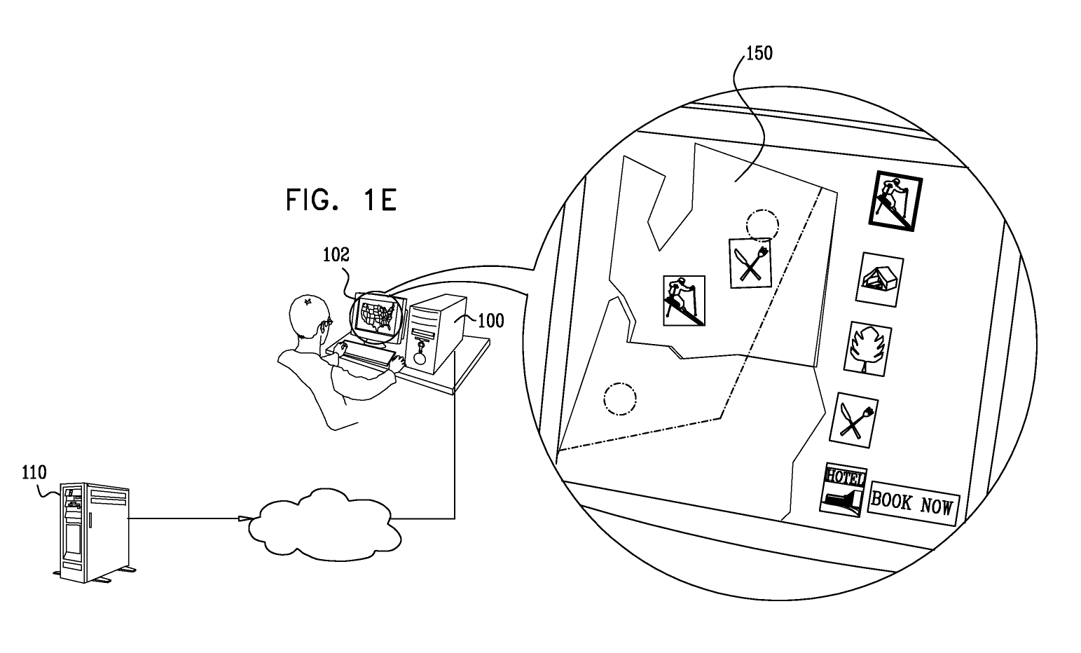

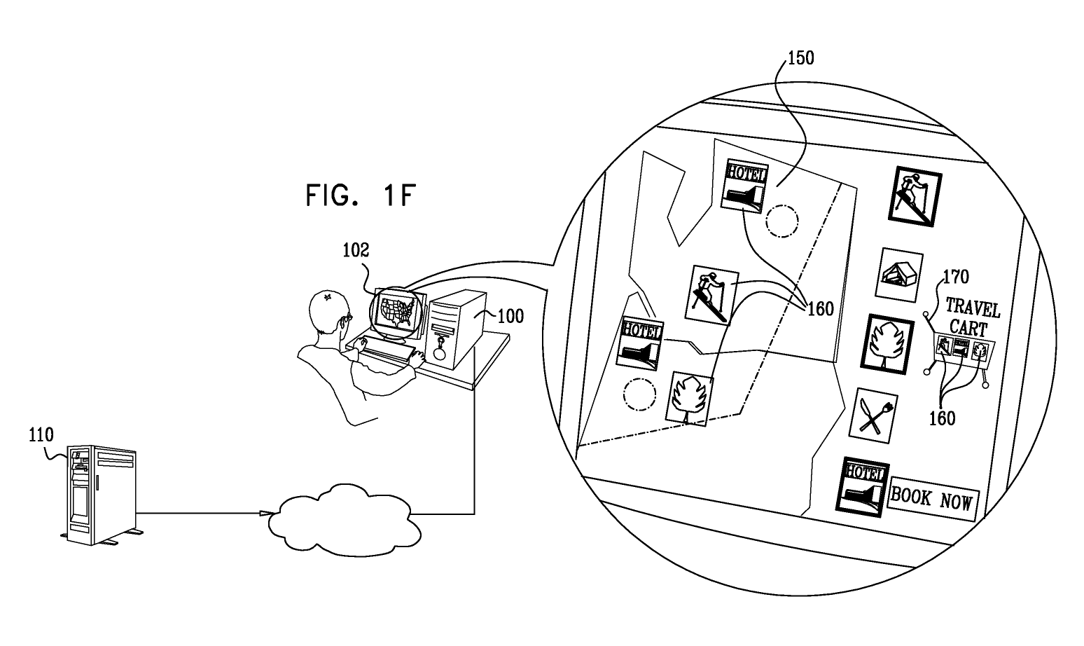

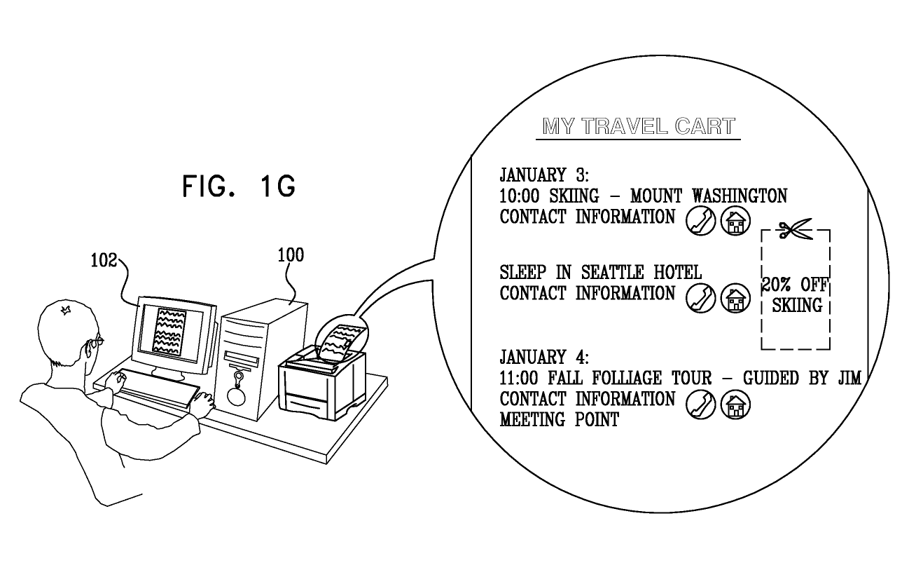

Reference is now made to FIG. 1A, which illustrates operation of a system for travel planning including a graphical user interface 100, such as any conventional Internet compatible computer including a display 102, operative to enable user designation of at least one desired travel parameter. Normally the system is configured for simultaneous communication with a multiplicity of such computers via the Internet 104.

An interactive computer system 110, typically embodied in one or more servers located remotely from the graphical user interfaces 100, is responsive to user designations for selecting at least one proposed travel region, the geographical boundaries of which are generally independent of political boundaries within a geographical area. Although a client-server type of architecture is primarily envisioned, it is appreciated that any other suitable type of architecture may be employed.

Desired travel parameters may be of various types and may relate, for example, to user interests or desired activities. Travel parameters may include weather considerations, season of travel, age group of the traveler, and cultural interests.

For example, user parameters relating to user interests may include parameters which may be classified as nature, industry and sports. As a more specific example, user parameters classifiable as “nature” may include waterfalls, rain forests, national parks, rock climbing, and mountains. Thus it is anticipated that a user may designate “national parks” as one desired travel parameter.

In accordance with a preferred embodiment of the present invention, responsive to the user's designation of “national parks” using a graphical user interface 100, the interactive computer system 110 selects one or more proposed travel regions 120 and displays them on display 102.

In accordance with one preferred embodiment of the present invention, the geographical boundaries of the proposed travel regions 120 are predetermined in accordance with the extent to which non-user designation specific proposed travel locations 122 are present therein. Non-user designation specific proposed travel locations 122 are points of interest or activities, which correspond to one or more desired travel parameters which are available for designation by users. Accordingly, in this embodiment, a proposed travel region may typically include Los Angeles or Las Vegas, since these areas contain many points of interest, corresponding to many user designatable desired travel parameters.

It is appreciated that the proposed travel regions 120 typically will not cover all of a given geographical area, such as the United States. Thus, parts of Iowa and Missouri, for example, which contain few, if any, points of tourist interest, may not be in any of the proposed travel regions. Normally, the proposed travel regions 120 do not overlap, but this is not a necessity.

For the purposes of the present description, proposed travel regions 120, which are at least partially based on the extent of presence within said geographical boundaries of user selectable proposed travel locations, are termed generic proposed travel regions. The system of the present invention may provide one or more collections of generic proposed travel regions 120. For example, users from the USA, who have a first generally known distribution of travel interests for travel in the USA, may employ a first collection of generic proposed travel regions 120, while users from Japan, who may have a second different, generally known distribution of travel interests for travel in the USA, may employ a second collection of generic proposed travel regions.

Thus, it may be seen in FIG. 1A that irrespective of whether a user designates SKIING or FACTORY TOURS as desired travel parameters, the user is presented with proposed travel regions selected from the same collection of generic proposed travel regions 120. As seen, however, a designation of SKIING normally results in display of a plurality of proposed travel regions 124 which are at least partially different from the plurality of proposed travel regions 126 resulting from a designation of FACTORY TOURS. As seen in the example shown in FIG. 1A, a proposed travel region 128, here covering Northwest Washington and the Cascades may be displayed in response to both designations as it includes the Boeing factory tour and Mount Baker. The geographical boundaries of the proposed travel regions do not vary in response to the designation of a given desired travel parameter.

According to an alternative embodiment of the present invention, depicted generally in FIG. 1B, the geographical boundaries of proposed travel regions 130 are predetermined in accordance with the extent to which user designation specific proposed travel locations 132, which are points of interest which correspond to one or more desired travel parameters actually designated by a user. Accordingly, in this embodiment, the geographical boundaries of a proposed travel region are determined at least in part by the desired travel parameters designated by a user.

Thus, it may be seen in FIG. 1B, that if the user designates SKIING as a desired travel parameter, the user is presented with a proposed travel region whose geographical boundaries are optimized to provide a maximum density of proposed travel locations 134 which are ski areas. Similarly, if the user designates FACTORY TOURS as a desired travel parameter, the user is presented with a proposed travel region whose geographical boundaries are optimized to provide a maximum density of proposed travel locations 136 which are factories. Normally, but not necessarily, the geographical boundaries of proposed travel regions corresponding to different desired travel parameters are not the same.

In the embodiment of FIG. 1B, a pre-set collection of user designatable travel parameters may be used. Alternatively, using known technology, a free text user input may be enabled to allow a user to somewhat freely configure one or more travel parameters.

In the embodiment of FIG. 1B, a pre-set collection of user-designation specific proposed travel locations may be provided or alternatively the user-designation specific proposed travel locations may be generated “on the fly” in response to user designations. Clearly, this latter alternative is suitable for free text user inputs.

Turning now to FIG. 1C, it is seen that irrespective of whether the embodiment of FIG. 1A or 1B is employed, the interactive computer system is operative to provide a ranking of the proposed travel regions responsive to the user designated desired travel input. This ranking normally appears in a color-coded or otherwise graphically user-friendly form, as shown. In FIG. 1C, the most preferred proposed travel region is designated by reference numeral 140 and sequentially lower ranking proposed travel regions are designated by reference numerals 142, 144 and 146.

FIG. 1D shows icons 148 which correspond to proposed travel locations which are ski areas within proposed travel regions 140, 142, 144 and 146.

FIG. 1E shows user selectable display of hotel, and restaurant locations in a selected proposed travel region 150 and interfaces for conventional booking functionality.

FIG. 1F illustrates user selection of proposed travel locations designated by icons 160 and collecting them in a “travel cart” 170.

FIG. 1G shows a typical printout which is provided to the user and which may further include advertisements specific to the user selected proposed travel locations collected in travel cart 170 (FIG. 1F).

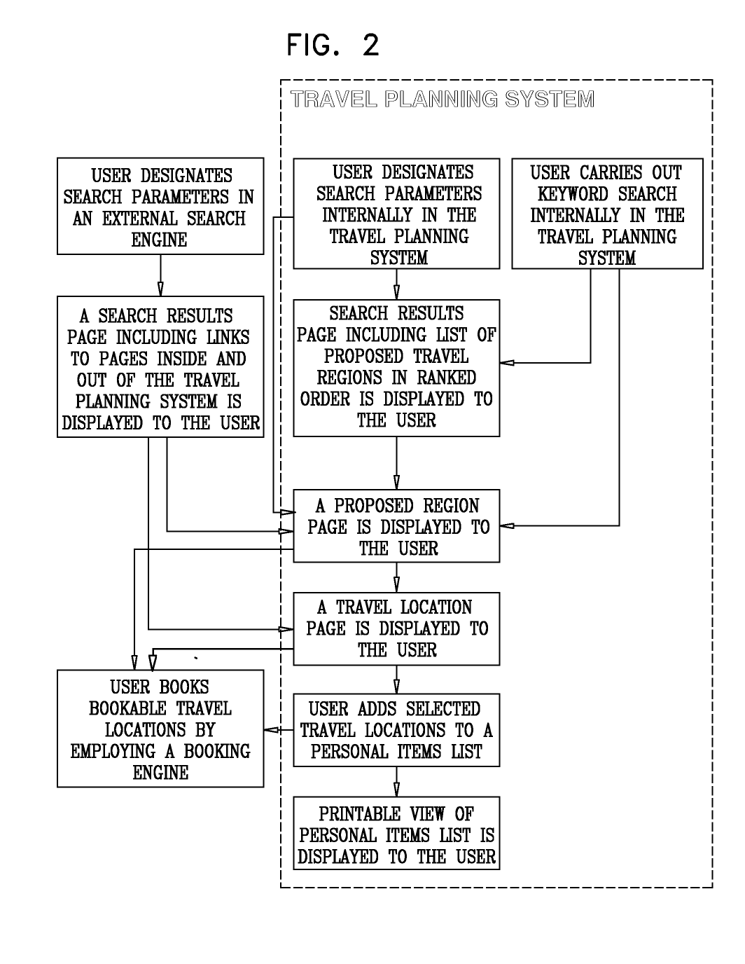

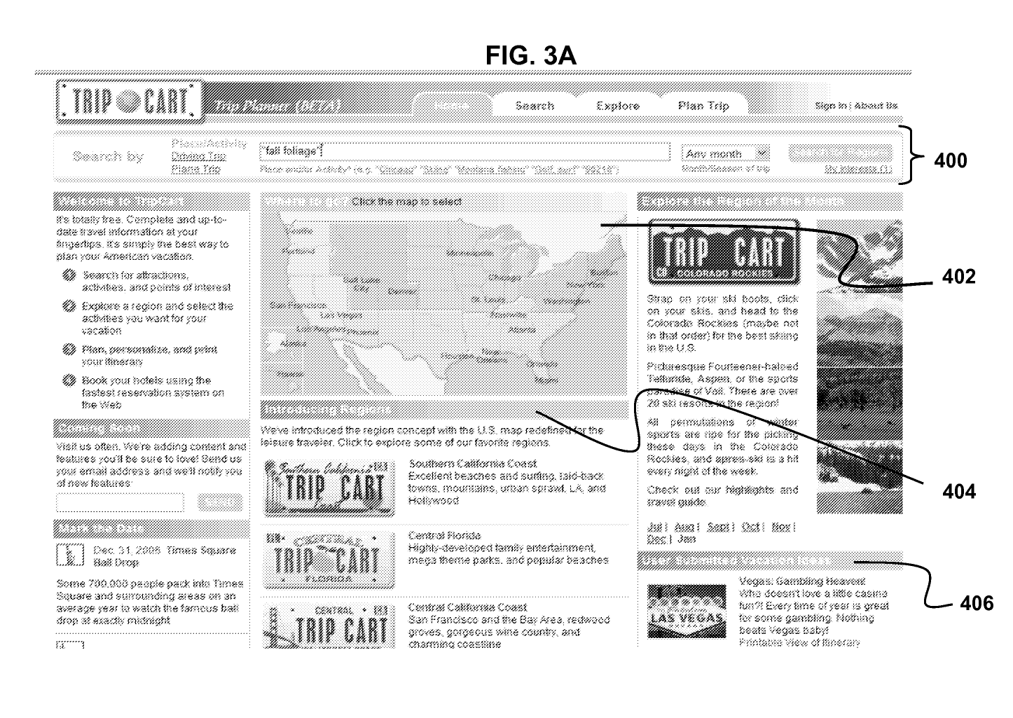

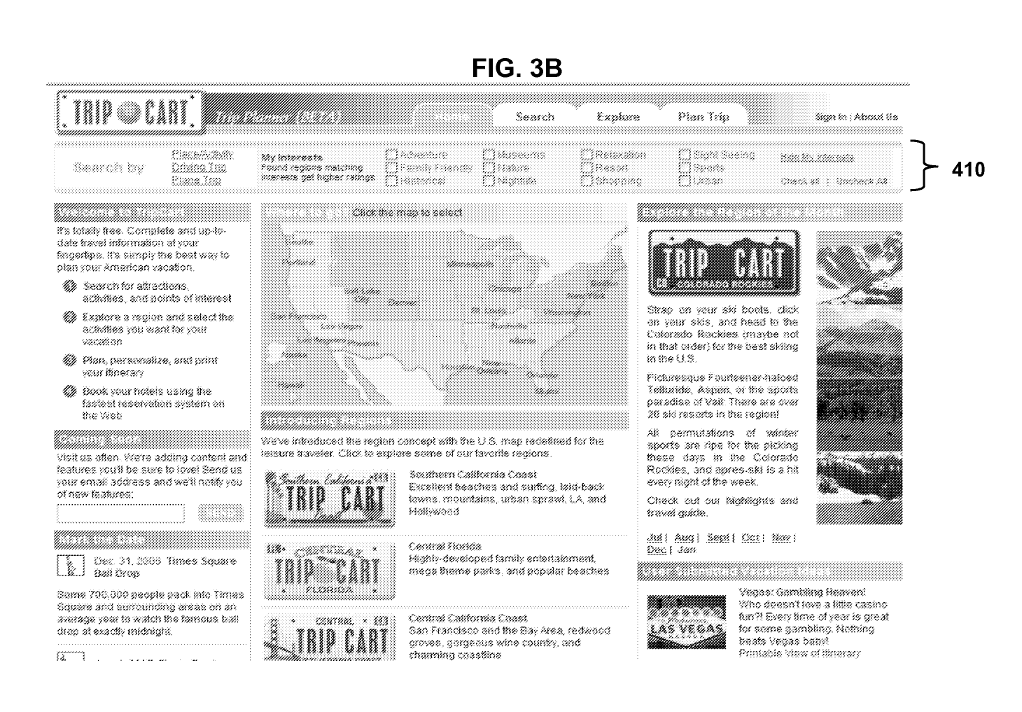

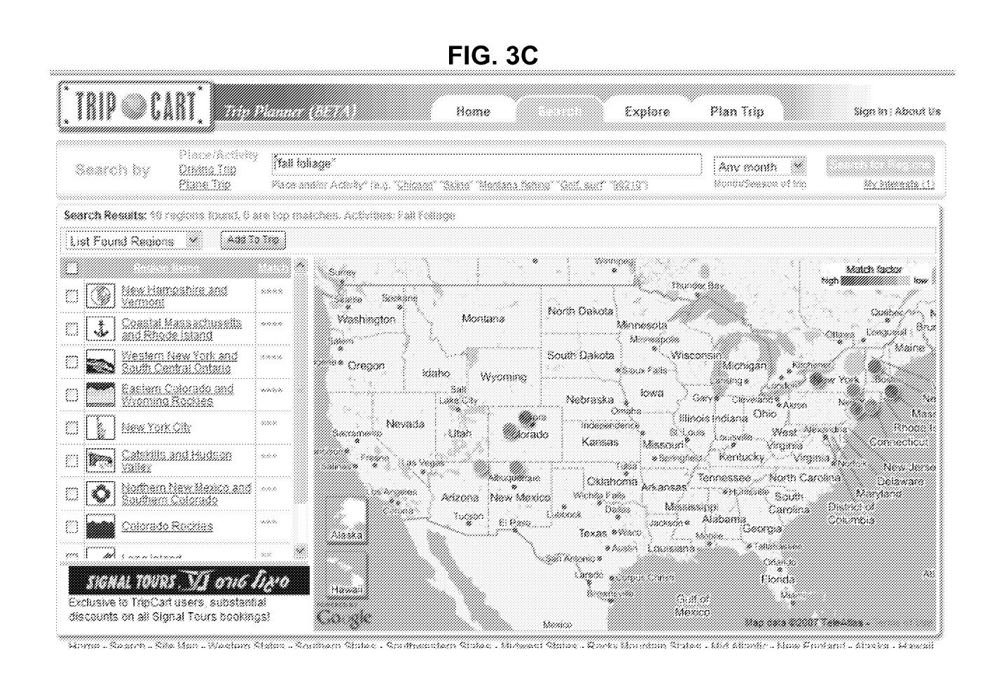

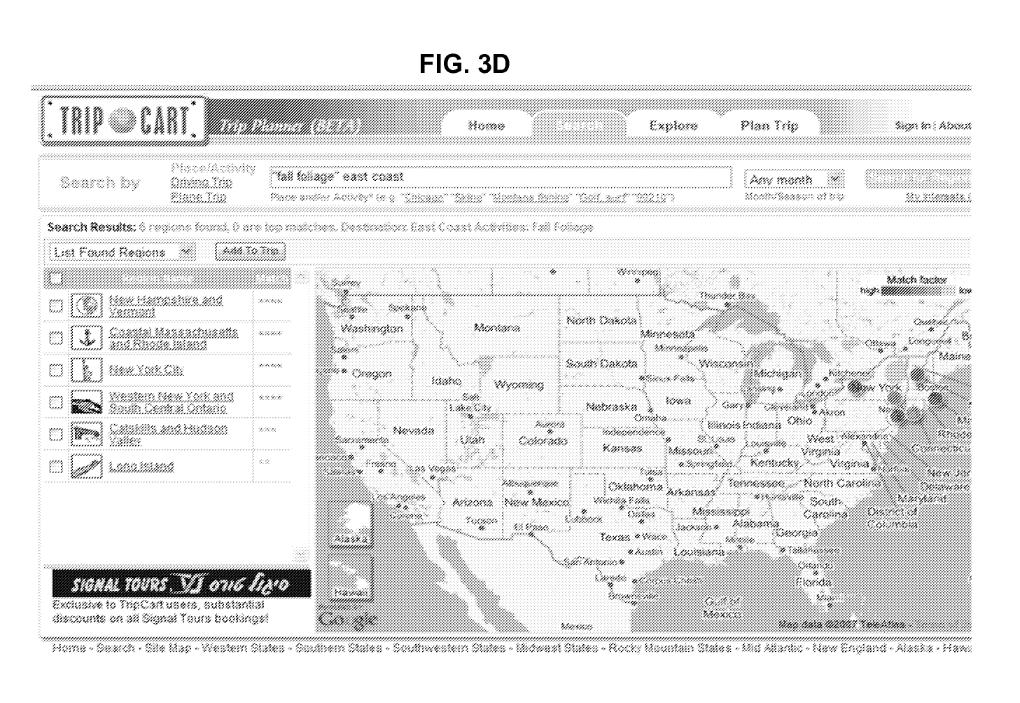

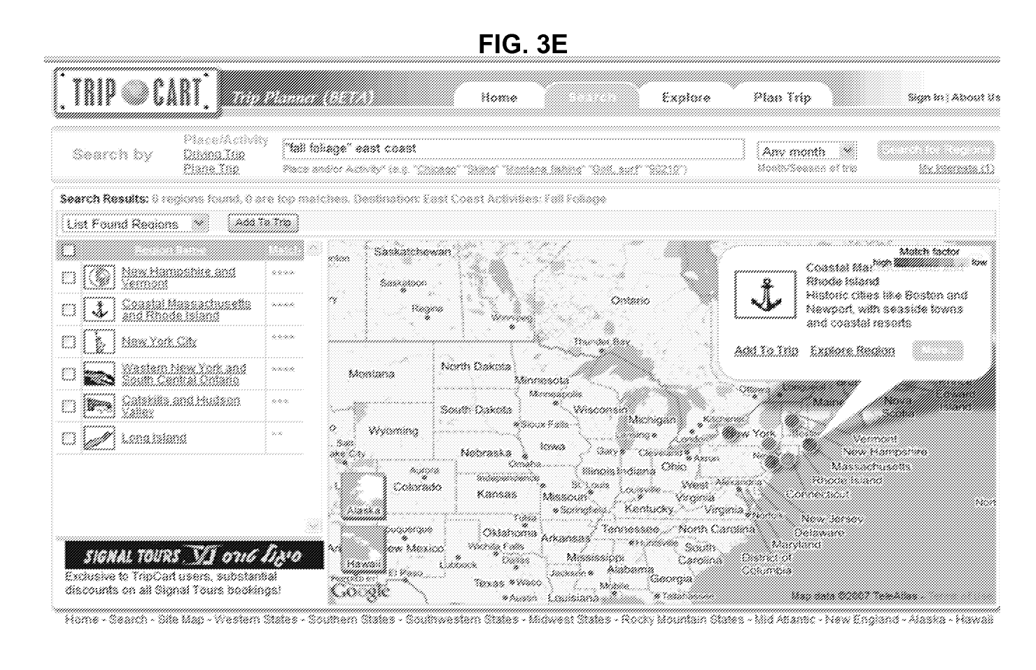

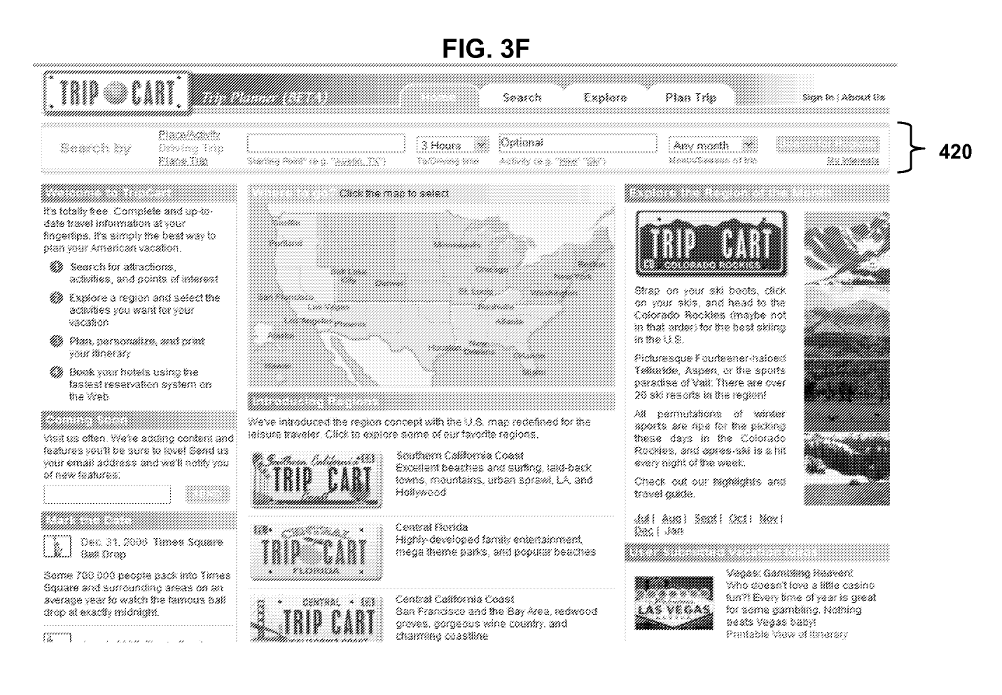

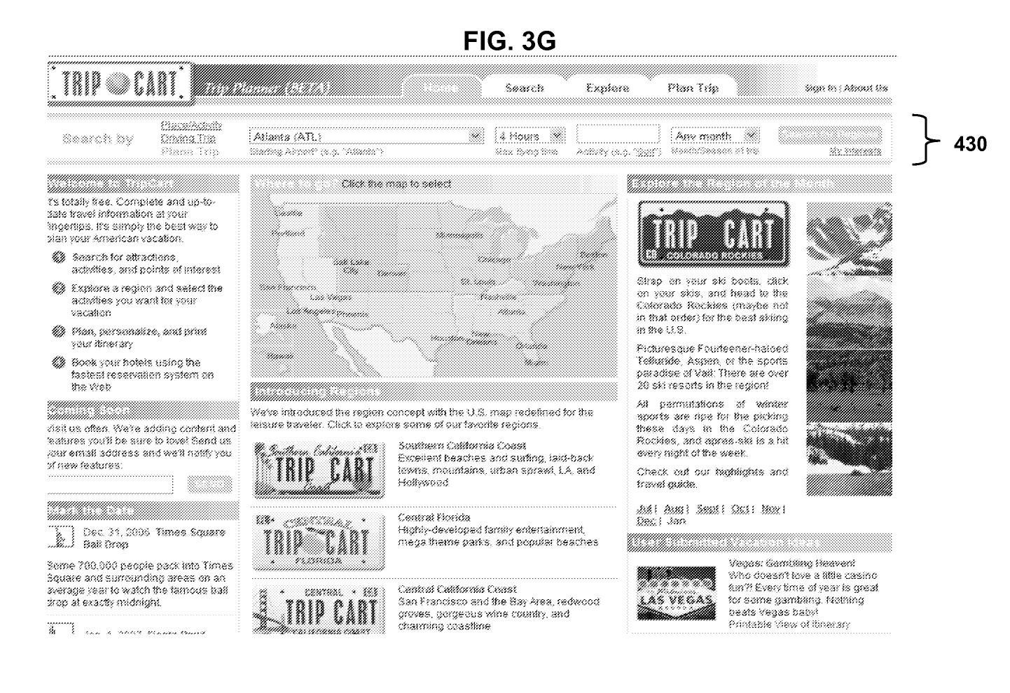

Reference is now made to FIG. 2, which is a simplified flow chart illustrating operation of preferred embodiments of the present invention, and to FIGS. 3A -3G, which are exemplary screen shots illustrating a computer screen as seen by a user at various stages of operation of the present invention.

The first step of an activity based trip planning process typically includes the designation by the user of search parameters as described hereinabove with reference to FIGS. 1A-1B. Alternatively the user search parameters may be designated at an online location, external to the trip planning system of the present invention, using a search engine as known in the art, wherein the results include one or more links to the travel planning system and/or to proposed regions thereof in accordance with the present invention.

When designating search parameters within the travel planning system herein termed an “internal search”, the user is typically presented with a list of proposed regions that include travel locations corresponding to the user search parameters. Alternatively, the user may carry out a keyword search within the travel planning system. The results of the internal search are shown on a search results page, such as that shown in FIG. 3C, which typically includes a list of matching regions ranked by a match factor and a map with an indicator showing each matching region. It is appreciated that more than one type of indicator may be used to provide a graphic and visible hint regarding the match factor. For example the current travel planning system uses a blue circle as an indication for a proposed region. A darker (more opaque) blue circle indicates a better match based on the user search parameters entered in the internal search.

Mousing over or selecting the circle indicator typically opens a tabbed or single frame balloon containing a brief description of a proposed region and a link to the region top level view, such as that shown in FIG. 3E. It is appreciated that if only a single region matches the user search, the search results may bring the user directly to the top level region view for a relevant proposed region. If there are no matches corresponding to the user search parameters designated by the user internally, the search result page may show a plurality of regions in the geographic area or alternatively may offer a message indicating that the user should refine his search or check his spelling.

As a result of the external or internal search, the user reaches a proposed region page.

Each proposed region is typically associated with a top level view including a map showing the general geographic area of the proposed region, a context sensitive list of activity icons corresponding to different types of travel locations in the proposed regions, hotel indicators/icons corresponding to hotel locations in the proposed region, and travel guide information. In addition, the proposed region may be associated with routes of interest for the region, user information, user reviews of travel locations in the proposed region, photographs of items or landscapes in the proposed region or similar trips planned by other users including visits to the travel locations in the region. The proposed region may be further associated with themed suggestions for trips in the proposed region (romantic getaway suggestions, family friendly suggestions, pet friendly suggestions).

It is appreciated that context sensitive or other advertisements are typically integrated into the region views.

It is appreciated that any travel location viewable on the map or in the guide may be added to a personal item list, here termed a “tripcart” using the “add to trip” button specific to that item. It is further appreciated that hotels may also be added to the personal item list using the same methods and techniques for inclusion. In accordance with an alternative embodiment of the present invention, users may add customized items such as “my grandmother's house” to the personal item list.

The personal item list, i.e. tripcart, preferably is a personalized database including travel locations selected for inclusion by the user from a view of the proposed region or alternatively including items selected from any of the “item pages”. It is appreciated that the personal item list may be public, shareable with other users, private, or available to an invited group of users. It is appreciated that each personal item list typically corresponds to a single trip that the user is planning and that more than one personal item list may be maintained by the user.

For each travel location in the personal item list, the user may add date information, notes and confirmation numbers. The printable view of the personal item list is arranged logically to provide the user with a compact, easy to use, trip itinerary. It is appreciated that advertisements relating to the region or to the travel location may be included in the printable version of the personal item list. For example, a user who has selected a hiking area as an item in his personal item list may receive a coupon for purchase of camping equipment at a store in the region, nearby his selected hotel.

A booking engine as known in the art may be integrated with the personal item list to enable seamless booking of the bookable travel locations in the personal item list. Alternatively, the booking engine may enable booking of travel locations directly from views of the region page.

Reference is now made to FIG. 3A, which is an exemplary view of the home page of the activity based travel planning system described herein. In this home page view, the user sees several techniques for searching, which may include: a search bar 400 for the designation of user search parameters; a map based search (“where to go”) area 402; a search area 404 based on popular regions (“Introducing regions”); and a search area 406 based on other user's trips (“User submitted vacation ideas”).

In the example shown, the user has designated “fall foliage” as the user search parameters in the search bar 400.

FIG. 3B is an exemplary view of the home page with check boxes 410 for enhancement of the user search parameters by adding user interests to be considered when searching for matching regions.

FIG. 3C is an exemplary view of a search results page, based on the user search parameter “fall foliage”. In the example shown, ten regions have been calculated as matches by the internal search algorithm, with no regions marked as top matches. The match factor, or star rating in the list of regions, corresponds to the opacity of the circle marking the region on the map with a darker blue circle indicating a higher match.

FIG. 3D is an exemplary view of a search results page, based on the user parameters “fall foliage” and “east coast”. It is appreciated that regions in the Western part of the United States that appear on the search results page shown in FIG. 3C are omitted from the search results shown in FIG. 3D, in which the user search parameters include the keywords “east coast” in addition to “fall foliage”

FIG. 3E is an exemplary view of the search results page of FIG. 3D with the balloon of the region entitled “Coastal Massachusetts” open. By dividing the United States into regions in accordance with the algorithm described hereinbelow, each region can be generally characterized to give the user a brief summary of the region type. The brief summary may be shown in a balloon or pop-up window to enable a quick comparison of abstract items, such as regions of the US.

FIG. 3F is an exemplary view of the “search by driving trip” view of the home page. In this case, a search bar 420 allows designation of user search parameters to include a starting point, a driving time, an activity, or any combination thereof. The search results take into consideration the additional user search parameters in order to return regions that meet the user's requirements.

FIG. 3G is an exemplary view of the “search by plane trip” view of the home page. In this case, a search bar 430 allows designation of user search parameters to include a starting airport, a flying time, an activity or any combination thereof. The search results will then take into consideration the additional user search parameters in order to return regions that meet the user's requirements.

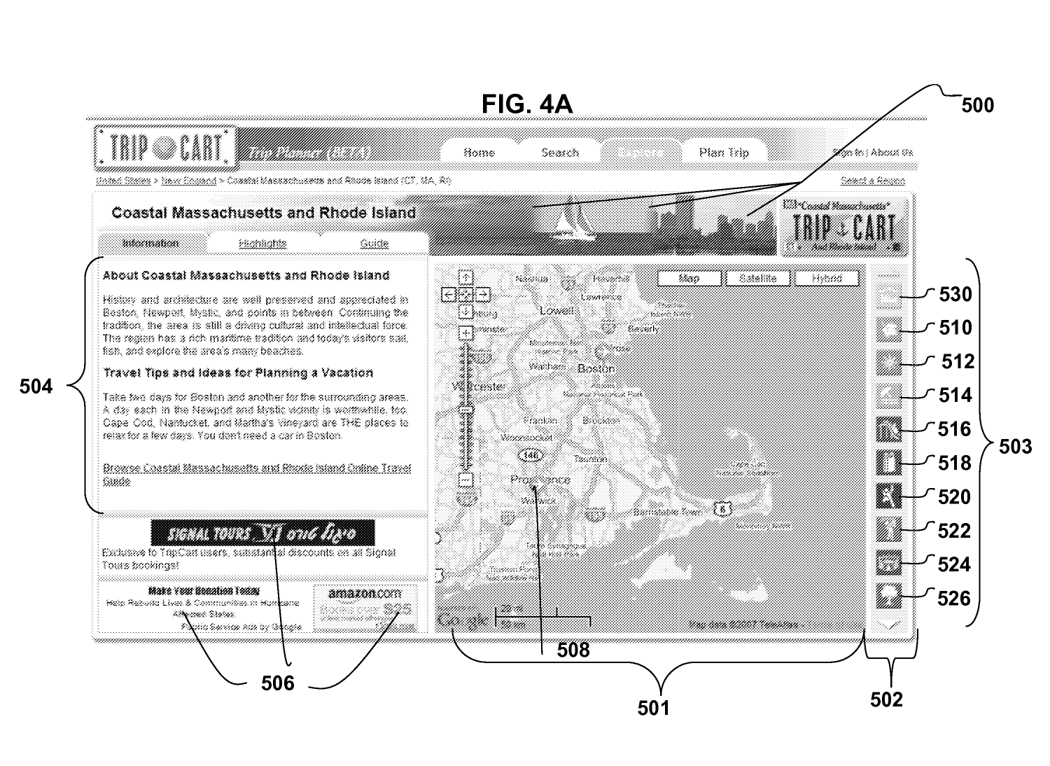

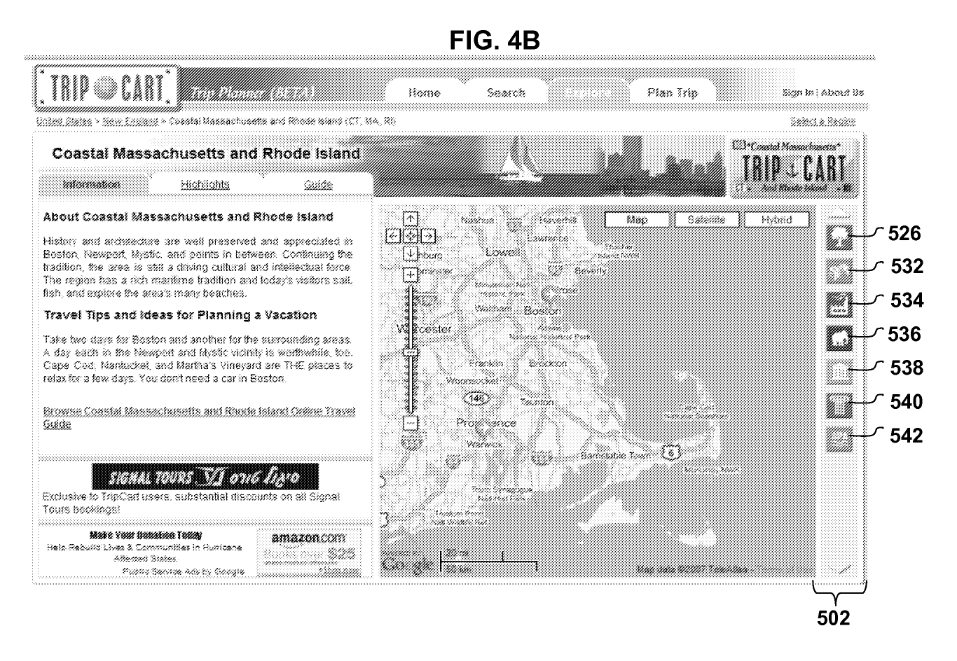

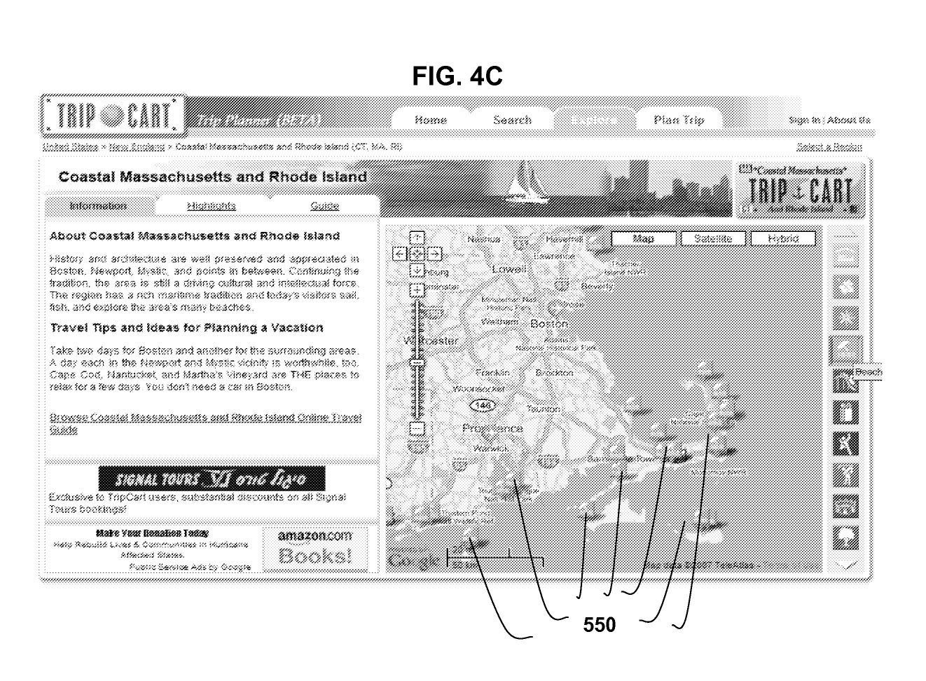

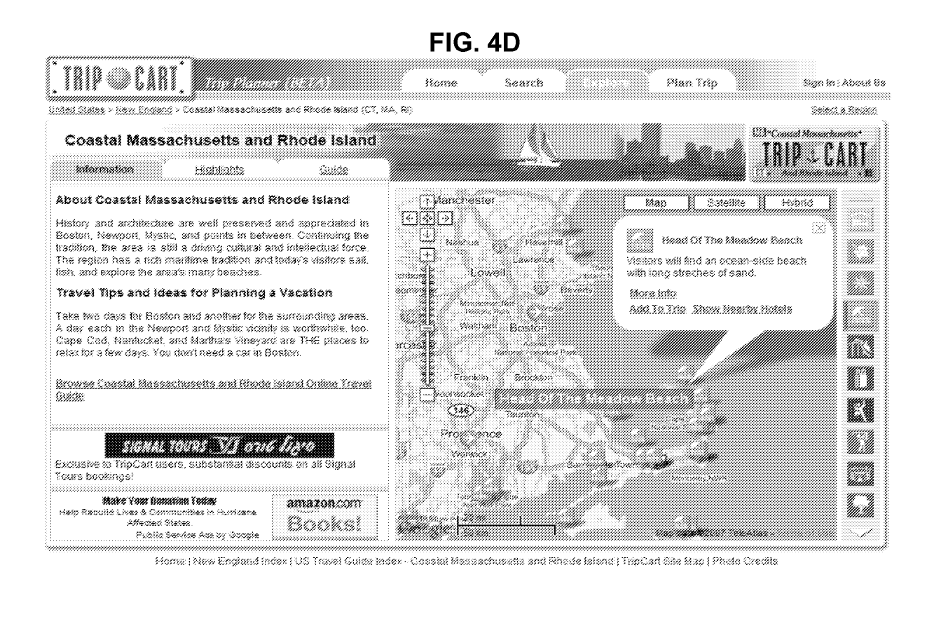

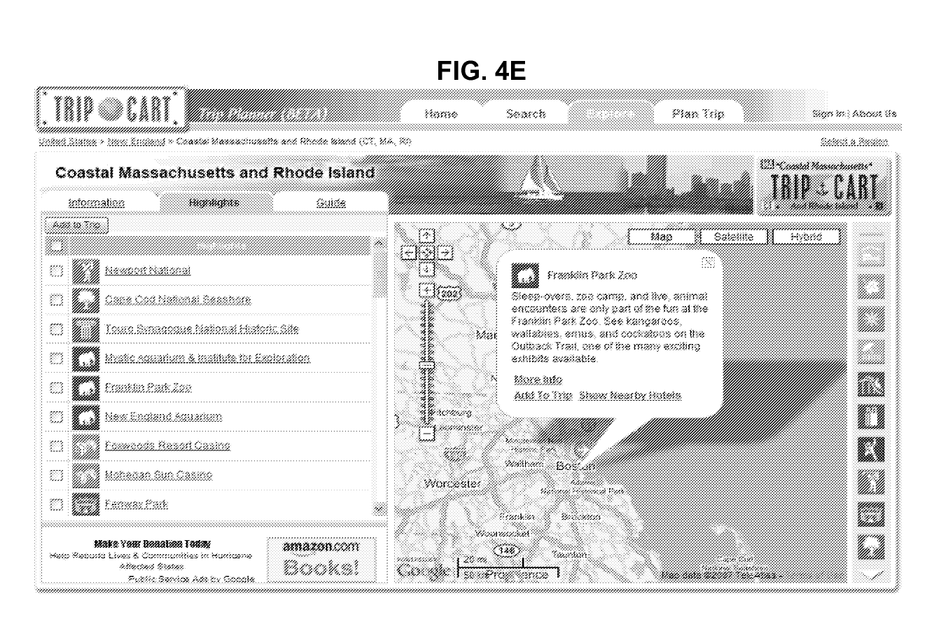

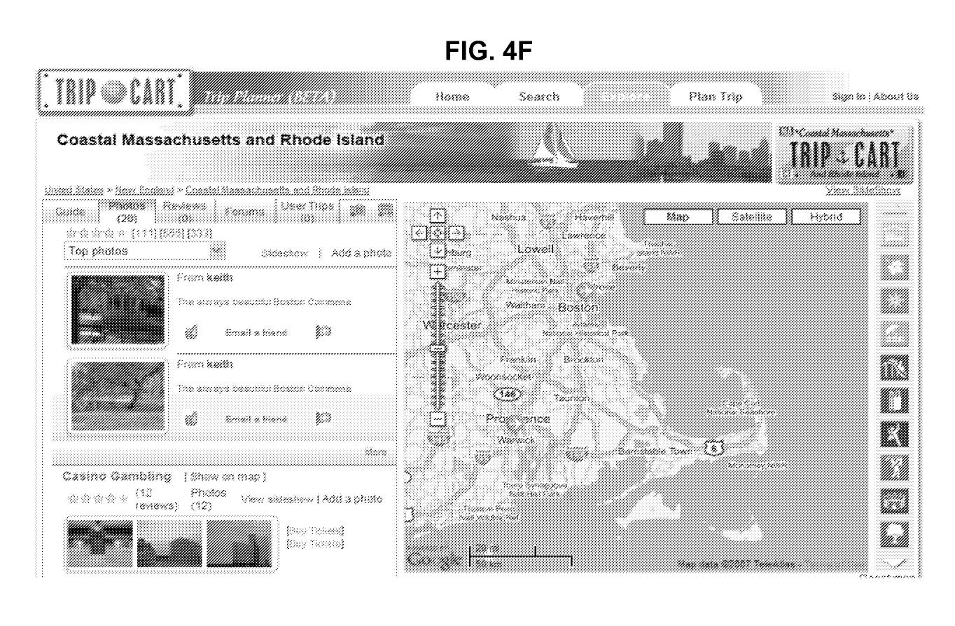

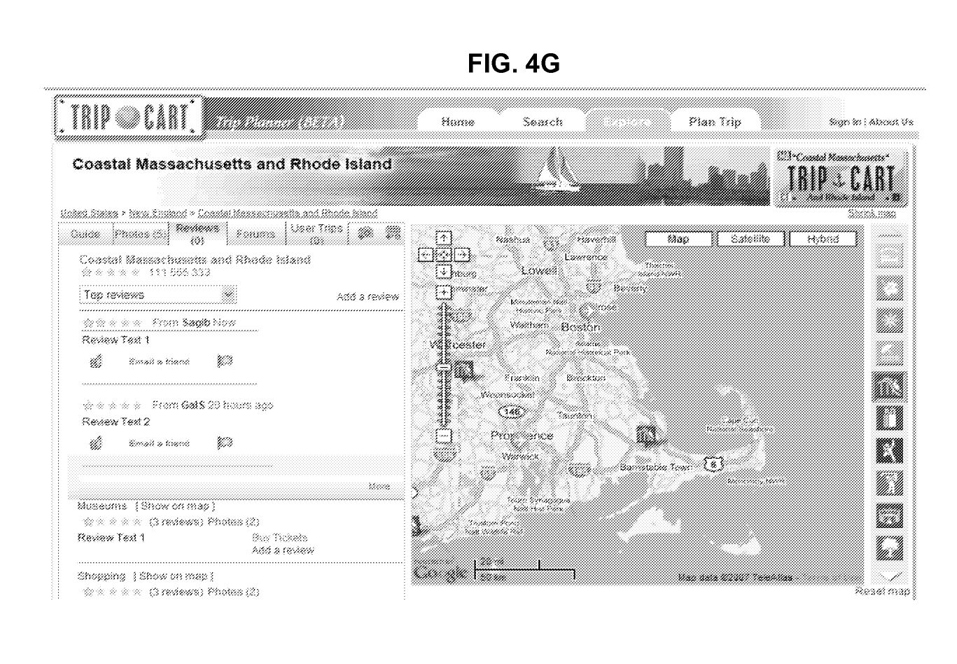

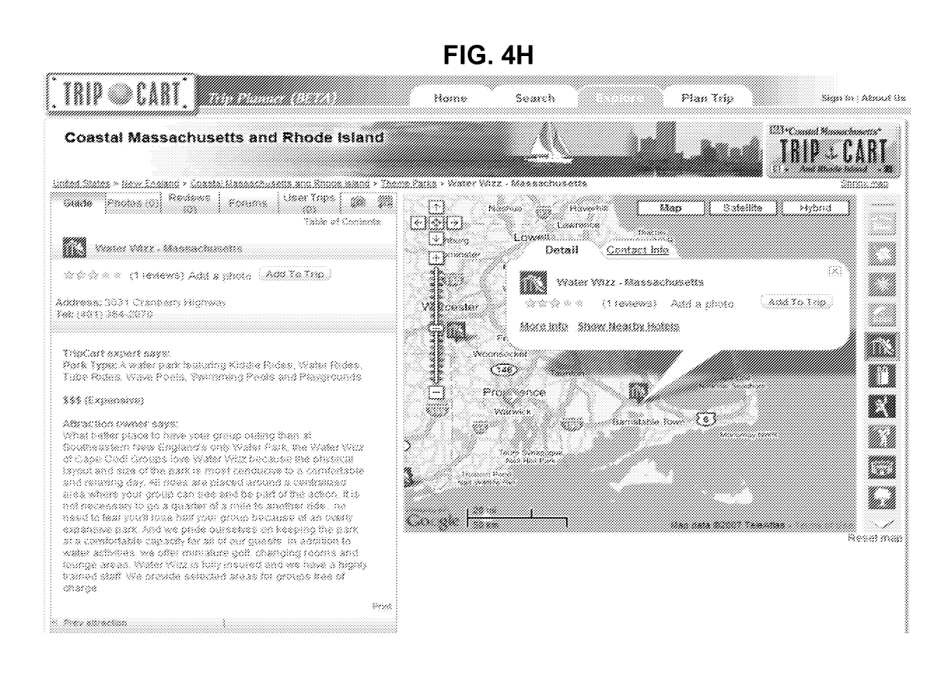

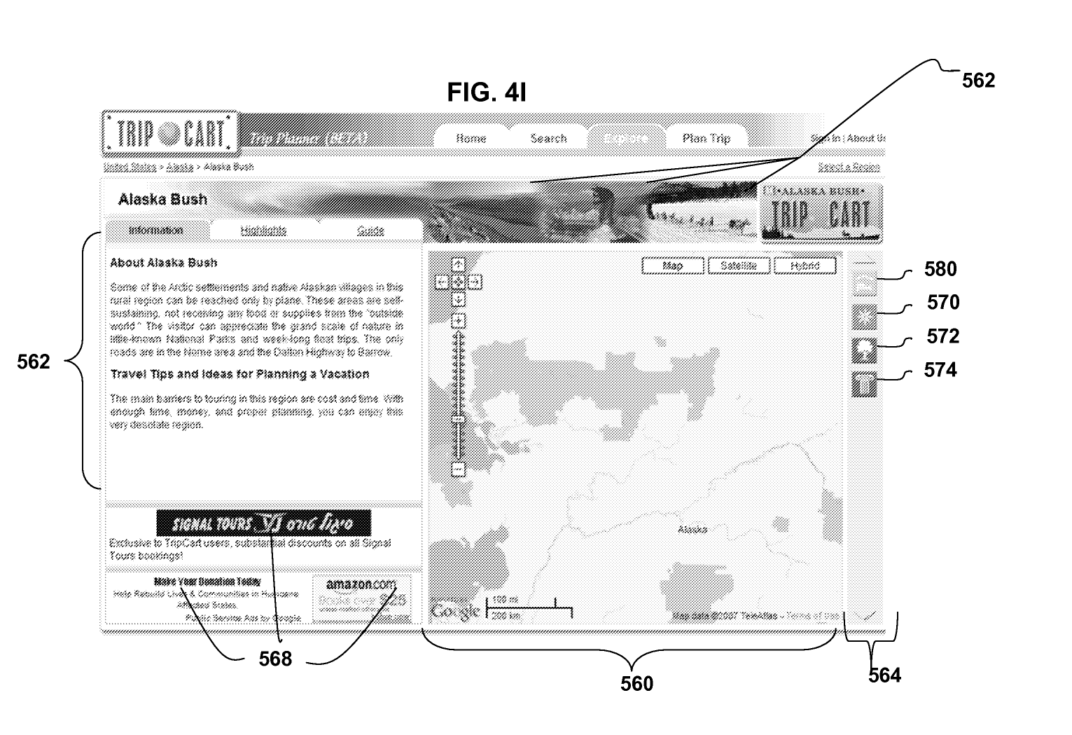

Reference is now made to FIGS. 4A-4I, which are exemplary screen shots illustrating a computer screen as seen by a user at various further stages of operation of the present invention. Specifically, FIGS. 4A-4G present views of a region page, which is accessible from the search results page or alternatively may be reached via a search external to the trip planning system. FIG. 4H presents views of a travel location page and FIG. 4I presents a view of a second proposed region page. It is appreciated that an external search is typically a straight keyword search and is not based on user search parameters and interests as described hereinabove.

FIG. 4A is an exemplary top level view of a region page showing photographs of the region 500, a map 501 showing the general area of the region at a first zoom level, an activity icon toolbar 502 including a plurality of activity icons 503, part of the text-based travel guide 504, and advertisements 506. In addition, the top level view of the region page typically includes transportation gateways, such as airports, for that region as indicated by a grey airplane symbol having reference numeral 508.

It is appreciated that each proposed region is associated with a list of travel locations in the region, grouped by type. Preferably, each travel location type corresponds to a unique icon 503 presented on the activity icon toolbar 502.

It is a particular feature of the present invention that the activity icon toolbar 502 is context sensitive to a proposed travel region and only includes the activity icons 503 corresponding to types of travel locations which are included on the local travel location list of the region being viewed. For example, the activity icon toolbar for Florida does not include a “ski” icon and the activity icon toolbar for Colorado does not include a “beach” icon. This facilitates activity/interest based travel planning by enabling the user to quickly and easily view types of activities that correspond to and characterize a specific region. Typically the activity icons 503 are graphically distinguishable from each other.

User selection of an activity icon 503 causes an overlay layer corresponding to that type of activity to appear over the map. “Pushpin icon indicators”, corresponding to individual travel locations of the type selected, mark the physical locations of the travel locations in the proposed region. For example, in the Central Florida region, selecting a “theme parks” activity icon causes pushpin icon indicators to appear for the Disney parks, Universal studios etc. Selecting a “theme parks” activity icon in the Colorado region shows local theme parks in that particular proposed region only, irrespective of the zoom level of the map.

Each pushpin icon indicator further includes a balloon containing additional information about the specific travel locations marked thereby. In addition, the balloon may contain links to a specific “travel location page” which contains more detailed information specifically about that travel locations. An exemplary travel location page is shown in FIG. 4H. It is appreciated that several layers may be concurrently overlaid on the map.

As an optional feature, the user may decide to hide or show a subset of the activity icons from the activity icon toolbar.

The activity icon toolbar shown in FIG. 4A includes a fall foliage icon indicated by reference numeral 510, a points of interest icon indicated by reference numeral 512, a beaches icon indicated by reference numeral 514, a theme parks icon indicated by reference numeral 516, a shopping icon indicated by reference numeral 518, a rock gyms icon indicated by reference numeral 520, a golf icon indicated by reference numeral 522, a spectator sports icon indicated by reference numeral 524 and a nature icon indicated by reference numeral 526.

In addition, a hotel icon, indicated by reference numeral 530, is included on the activity icon toolbar 502 to enable the user to view hotels in proximity of the items of interest.

FIG. 4B is an exemplary top level view of the region page of FIG. 4A further illustrating the activity icon toolbar in a scrolled up position. In this position, further icons, representing the following additional types of travel locations, are visible: a gambling and casinos icon indicated by reference numeral 532, a factory tours icon indicated by reference numeral 534, a zoos icon indicated by reference numeral 536, a museums icon indicated by reference numeral 538, a historical sites icon indicated by reference numeral 540 and a spas icon indicated by reference numeral 542.

FIG. 4C is an exemplary “single activity layer” view of a region page having the beach activity icon selected, causing an overlay layer for beach travel locations to appear on the map. Pushpin icon indicators 550 corresponding to the beaches type of travel location in the geographical region area are also shown on the map.

FIG. 4D is an exemplary “single activity layer” view of a region page with the beach activity icon selected causing an overlay layer for beach travel locations to appear on the map. In this view, a single travel location, namely “Head of the Meadow” beach, is selected on the map, and details thereof are shown in a balloon.

FIG. 4E is an exemplary highlight view of a region page showing, on the left side thereof, a list of highlights of the region. It is appreciated that the list of highlights typically combines different types of activity icons corresponding to different types of travel locations. In this view, a single item is selected on the map and details thereof are shown in a balloon.

FIG. 4F is an exemplary photo view of a region page including photographs which are relevant to the region or to the map overlay activity layers being viewed. It is appreciated that photographs may be user submitted by employing techniques for submitting photographs, as is well known in the art.

FIG. 4G is an exemplary review view of a region page including “user reviews” which are relevant to the region or to the map overlay activity layers being viewed. It is appreciated that user reviews are typically submitted using techniques for submitting reviews or user content as is well known in the art.

FIG. 4H is an exemplary information view of a travel location page for a specific travel location, selected from a local travel location list of a region. The travel location page typically includes expert content as well as user generated content. The travel location page may further include particular details of the travel location including contact information, etc. Alternative views of the travel location page may include photo views including photographs specific to the travel location page, reviews including user or professional views specific to the travel location, forum views showing local forum topics relevant to the travel location or other user trip views showing other user trips including the travel location described in the page viewed.

FIG. 4I is an exemplary top level view of a second proposed region showing a general map of the region 560, photographs of the region 562, an activity icon toolbar 564, part of the travel guide 566 and advertisements 568.

It is appreciated that the local travel location list for this region includes considerably fewer types of travel locations. Thus, the activity icon toolbar 564 for this second region includes far fewer activity icons than the toolbar of the region illustrated in FIGS. 4A-4H above. The activity icon toolbar 564 includes representation of the following types of travel locations: points of interest 570, nature 572 and historical sites 574. A hotel icon 580 corresponding to hotels in the second proposed region is also included.

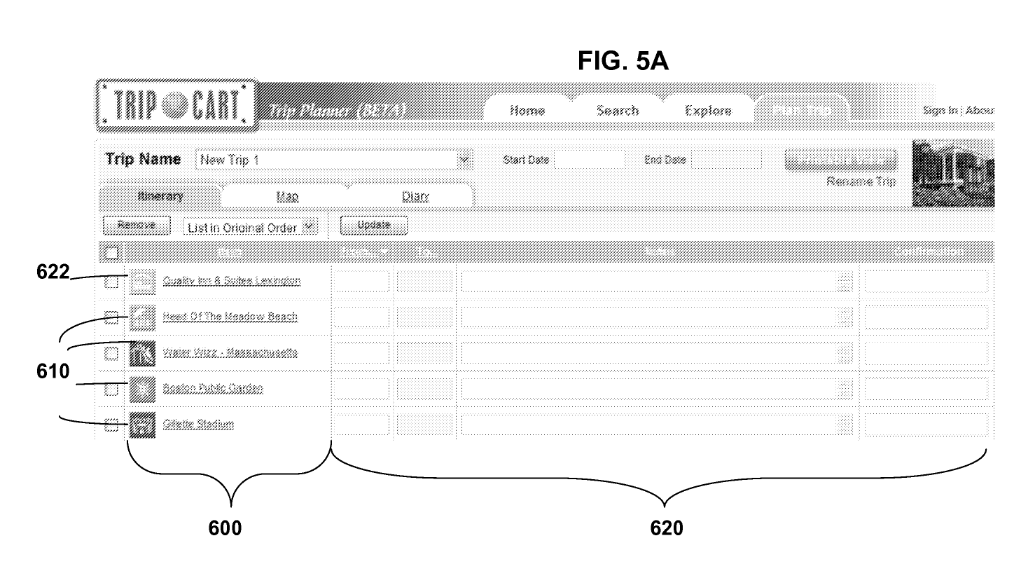

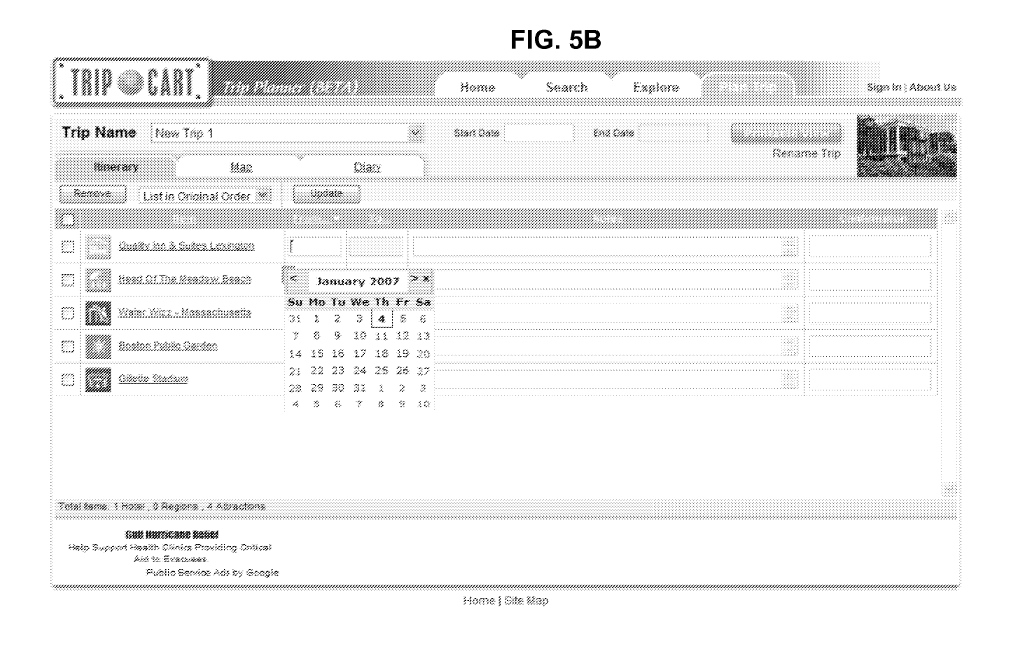

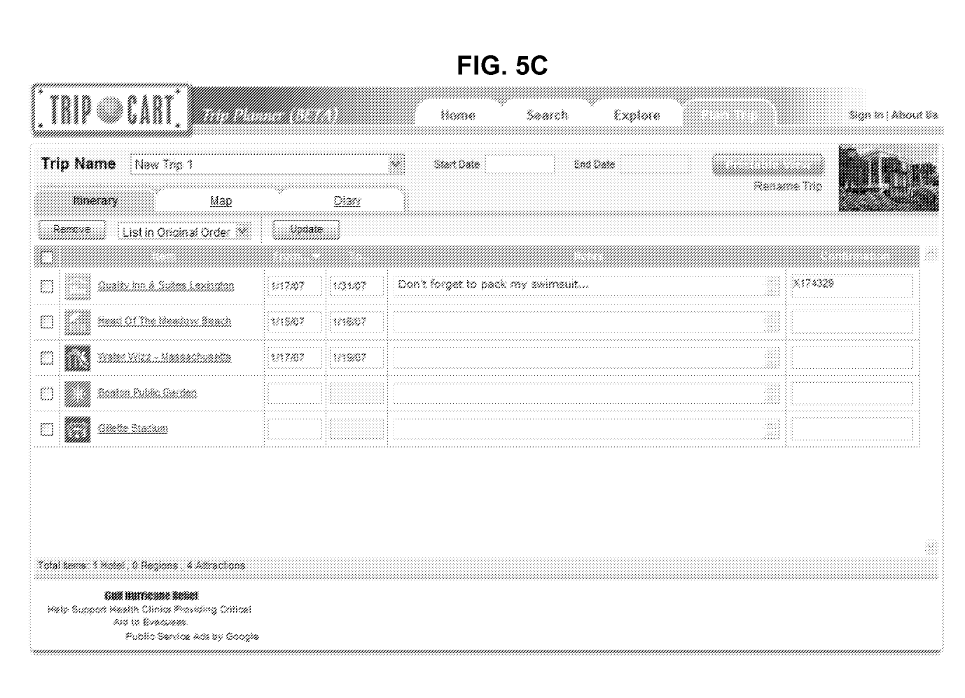

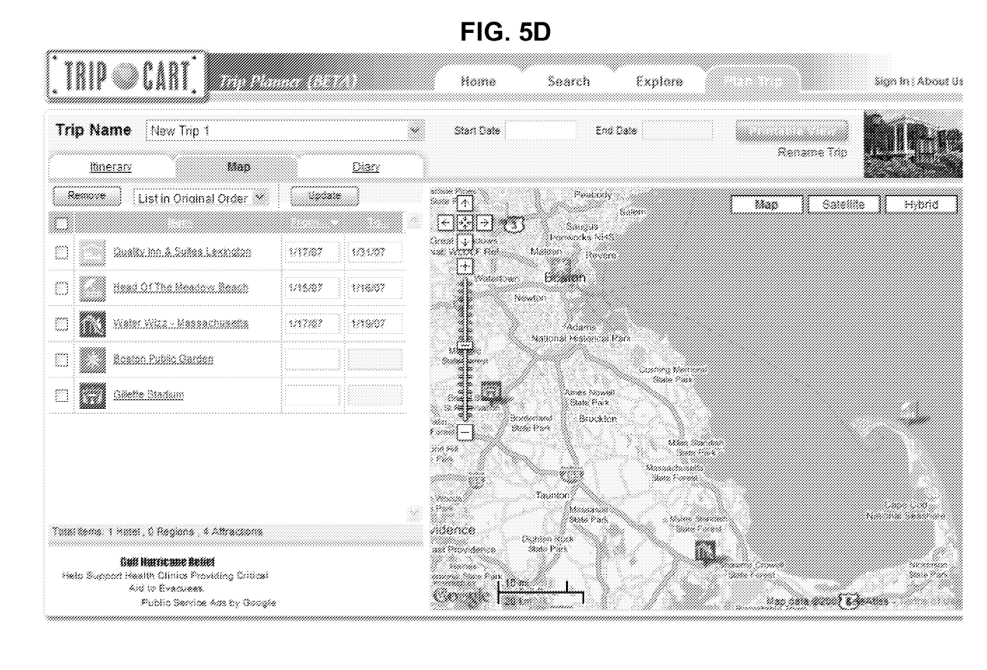

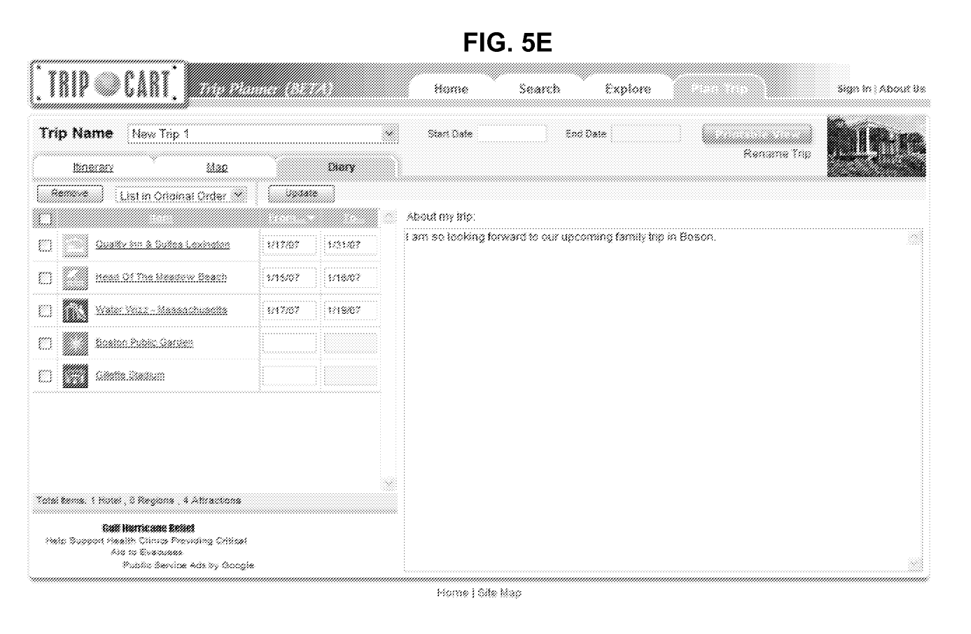

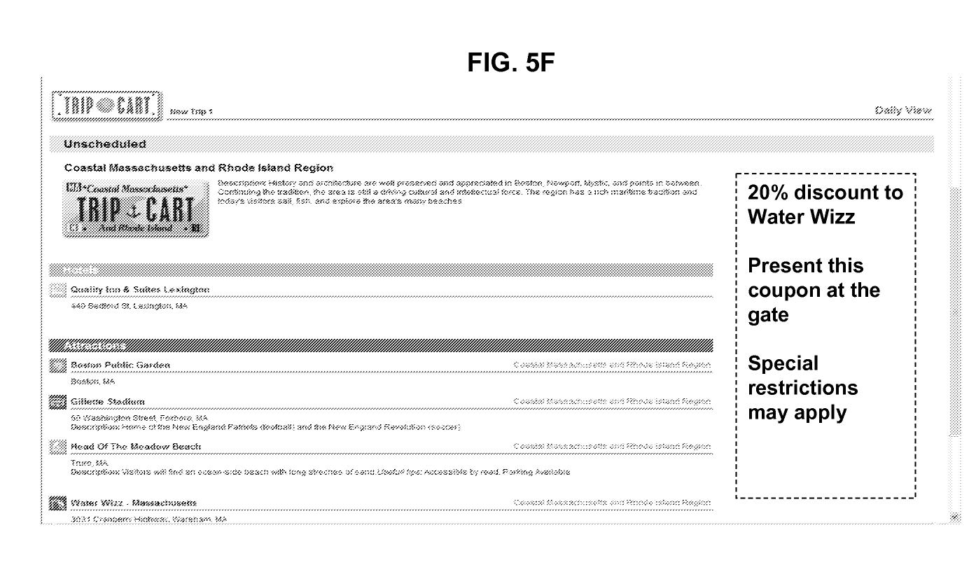

Reference is now made to FIGS. 5A-5F, which are exemplary screen shots illustrating a computer screen as seen by a user at various additional stages of operation of the present invention. Specifically, FIGS. 5A-5F illustrate a user interface for a personal item list, also termed the personalized user database, in accordance with a preferred embodiment of the present invention.

FIG. 5A is a top level itinerary view of a personal item list including an item list 600 including one or more travel locations 610 that have been added thereto via an “add to trip” button of that travel location. Each travel location 610 in the personal user list is preferably associated with selectably fillable fields 620 in which a user can add a date selection, user notes or confirmation numbers. It is appreciated that travel locations 610 included in the personal user list may be selected from one or more regions. The personal item list may also include one or more hotels 622. In accordance with a further embodiment of the present invention, flights and or other custom user icons may also be addable to the personal user list.

FIG. 5B is a top level itinerary view of the personal item list of FIG. 5A showing a date selector for a specific hotel on the personal item list.

FIG. 5C is a top level itinerary view of the personal item list of FIG. 5A showing data that has been entered into fields of several of the travel locations and of the hotel.

FIG. 5D is a map view of the personal item list of FIG. 5A. In this view, pushpin icon indicators appear on the map and show the location of each included travel location and hotel. It is a special feature of the present invention that the map size is adjusted to the zoom level required to show all items from the personal user list on the map.

FIG. 5E is a journal/diary view of the personal user list of FIG. 5A where a user can enter free text describing his/her trip.

FIG. 5F is a printable view of the personal user list of FIGS. 5A-5E, easily arranged for user convenience. It is appreciated that the printable view of a personal user list may contain print ads or coupons, specific to the locations that the user will be visiting as described hereinabove.

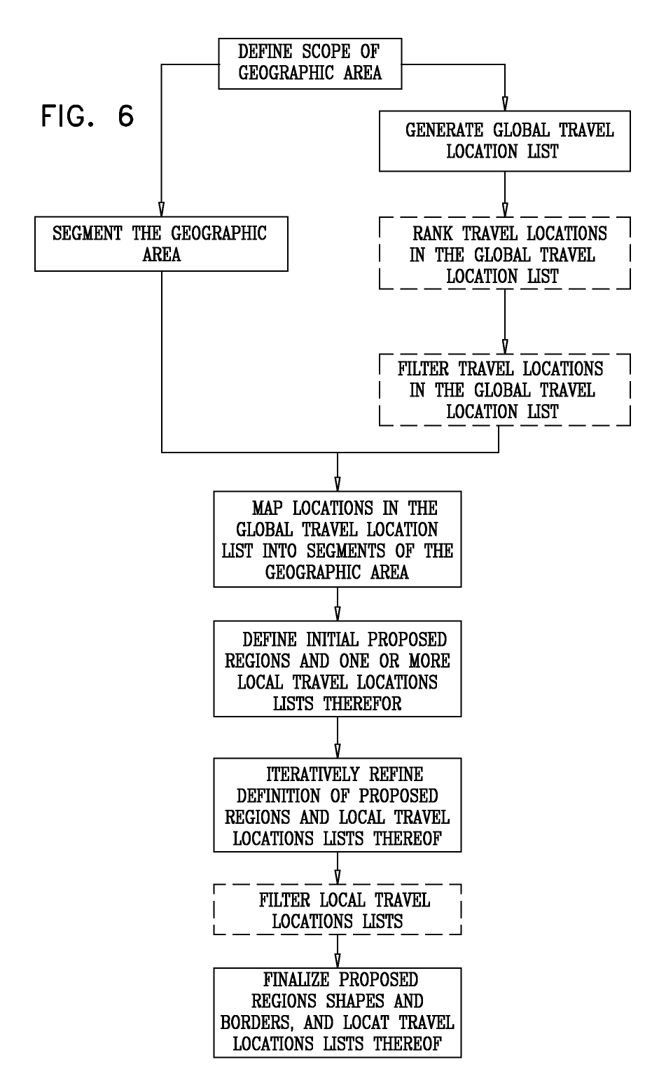

Reference is now made to FIG. 6, which is a simplified illustrative diagram of an algorithm employed in accordance with one embodiment of the present invention. The illustrated algorithm is used to generate regions and associated local travel location lists as described hereinabove in accordance with a preferred embodiment of the present invention.

For the purpose of the example shown, the scope of the geographical area included is defined as the political boundaries of the United States. It is appreciated that an alternative geographical entity, i.e. Europe, a city in the United States, a state in the United States, a country or any other geographical region may be used.

For the purpose of the examples shown herein, a travel location may be an attraction, an activity, or a place of interest. It is appreciated that for the purpose of the algorithm, hotels are not generally considered travel locations. However, certain hotels which are considered “destination” hotels are attractions and may be considered places of interest. For example, the Disney Boardwalk hotel in Lake Buena Vista, Florida may be considered a travel location.

The first step of the algorithm includes generation of a comprehensive global travel location list, covering travel locations in the geographical area defined by the scope. The global travel location list is preferably generated by gathering data from known travel resources such as publications from Professional Organizations, travel books, guides and magazines and online resources.

Preferably, the global travel location list includes information for each travel location, which may include some or all of the cost, location, size, number of visitors, type, suggested audience, facilities, address and type of location.

In addition, each travel location on the global travel location list is typically given a rating. The rating is preferably based at least on part of the following: frequency of mention in the sources used to generate the global travel location list, ranking in these sources, popularity and size.

The global travel location list is then typically filtered by at least one of the following filtering techniques: rating, thus including only travel locations with a rating above a certain threshold; size, thus including sites over a predetermined size threshold; uniqueness, such that unique items are not excluded from the global travel location list. Alternatively, travel locations may be rated but not filtered, or may not be rated at all.

The geographic area employed is typically segmented into distinct units. For example, a full zip code may be used to divide the United State into more than 55,000 segments. Alternatively, the first three digits of the zip code may be used to divide the United States into less than 1000 segments.

The global travel location list is then mapped into the segmented units, generating local travel location lists. It is appreciated that some segmented units may not be associated with a corresponding local travel location list.

Initial regions are proposed based at least partially on the local travel location lists and employing a set of rules used to define a general region shape and boundary. It is appreciated that regions as described herein may include one or more segments which do not have corresponding local travel location lists, in order to form a contiguous region. It is further appreciated that the local travel location lists for each segment in a proposed region are typically combined to form a local travel location list for an entire proposed region, which may further include hotels in the proposed region. The local travel location list and the types of travel locations covered thereby is the basis for the activity toolbar icon types described hereinabove.

An exemplary set of rules for initial region definition may include some or all of the following considerations:

a) Geographical Considerations:

A natural barrier, such as a river or canyon, may be considered a region defining border.

An island may be combined with a nearby land mass or with other islands

Climate/environment similarities—coastal vs. mountainous areas

b) Political Considerations:

Cities are generally not split between regions.

Regions are generally not defined in accordance with the political boundaries of states. Generally, parts of a single or multiple states become regions. However, in some implementations of the present invention, a state may be considered a region. Country borders may become region borders when the tourist sees a significance to the border, such as when there are changes of currency, entrance requirements, customs regulations and the like.

c) Transportation Considerations:

At least one major airport within the region boundaries

Train service where relevant

Half day driving time between any two items in the region.

No insurmountable barriers

A major tourist artery

d) Tourist Interest and Travel Location Considerations:

Similar interest “personality”.

Where the high rated items are located

Main family vacation destinations

Unique interests

The local travel locations list for a region and the region definition are preferably iteratively refined and may result in different collections of regions for users with different travel interests. In accordance with one embodiment of the present invention, proposed regions are generated “on the fly” in response to user designations.

It is appreciated that the local travel locations list may be filtered based on ratings, quantity and location of other travel locations of the same type in the region. In one case, a travel location may be removed because its rating is significantly lower than other similar travel locations in the proposed region. Alternatively, a low rated travel location may be included in a region if no similar types of travel locations appear in this region. Typically travel locations with a ranking significantly below the average rating calculated for other travel locations in that region are excluded.

In one embodiment of the present invention, the number of travel locations of a single type or activity for each region is targeted at being lower than fifty. It is appreciated that there are obvious exceptions to this generalization, such as casinos in Las Vegas or fall foliage in New Hampshire/Vermont.

The last step is finalizing the region borders, local travel location lists, and shapes. It is appreciate that the cumulative regions and resulting local travel location lists are not required to include 100% of the items from the global travel locations list in the geographic area defined by the border. Instead, the process of evaluating and dividing into regions is considered complete when, by the Monte Carlo method, a random sample of travel attractions and points of interest are extracted from the web or another travel source such as a guide book are applied to the region database to determine the percentage of tourist attractions included. A target percentage is over 90% of the tourist attractions listed in the other travel source.

It will be appreciated by persons skilled in the art that the present invention is not limited to what has been particularly shown and described hereinabove. Rather the scope of the present invention includes both combinations and subcombinations of the various features described hereinabove as well as modifications and variations thereof as would occur to a person of skill in the art upon reading the foregoing specification and which are not in the prior art.

1. A method for travel planning employing a computerized database query system, the method comprising:
user designation of at least one desired travel parameter; and
system presentation to user of at least one proposed travel region, based on said user designation, said at least one proposed travel region having geographical boundaries which are generally independent of political boundaries.

2. A method for travel planning according to claim 1 and also comprising:
system presentation to user of a visually sensible graphical map of said at least one proposed travel region bearing visually sensible indicia corresponding to proposed travel locations within said at least one proposed travel region corresponding to said at least one desired travel parameter.

3. A method for travel planning according to claim 2 and also comprising:
user designation of user-selected ones of said visually sensible indicia; and
system collection of travel locations corresponding to said user-selected ones of said visually sensible indicia.

4. A method for travel planning according to claim 3 and also comprising:
system generation of a proposed travel itinerary based at least partially on said user-selected ones of said visually sensible indicia.

5. A method for travel planning according to claim 1 and wherein said at least one desired travel parameter comprises a type of user activity.

6. A method for travel planning according to claim 1 and wherein said at least one desired travel parameter comprises a type of user interest.

7. A method for travel planning according to claim 5 and wherein said geographical boundaries of said at least one proposed travel region are selected at least partially by the extent of presence within said geographical boundaries of user selectable proposed travel locations.

8. A method for travel planning according to claim 1 and wherein said at least one proposed travel region has geographical boundaries which are determined at least in part by said at least one desired travel parameter designated by said user.

9. A method for travel planning according to claim 8 and wherein said at least one desired travel parameter is selected by said user from a prepared set of possible desired travel parameters available for designation by said user.

10. A method for travel planning according to claim 9 and wherein said geographical boundaries of said at least one proposed travel region are pre-determined for plural ones of said possible desired travel parameters available for designation by said user.

11. A method for travel planning according to claim 8 and wherein said geographical boundaries of said at least one proposed travel region are generated in response to designation of said at least one desired travel parameter by said user.

12. A system for travel planning comprising:
a graphical user interface operative to enable user designation of at least one desired travel parameter;
an interactive computer system responsive to said user designation for selecting at least one proposed travel region, geographical boundaries of said at least one proposed travel region being generally independent of political boundaries; and
a display presenting to said user in visually sensible form said at least one proposed travel region.

13. A system for travel planning according to claim 12 and wherein said interactive computer system and said display are operative to provide to said user a visually sensible graphical map of said at least one proposed travel region bearing visually sensible indicia corresponding to proposed travel locations within said at least one proposed travel region corresponding to said at least one desired travel parameter.

14. A system for travel planning according to claim 13 and wherein:
said graphical user interface is also operative for user designation of user-selected ones of said visually sensible indicia; and
said interactive computer system includes functionality for collection of travel locations corresponding to said user-selected ones of said visually sensible indicia.

15. A system for travel planning according to claim 14 and wherein said interactive computer system includes functionality for generation of a proposed travel itinerary based at least partially on said user-selected ones of said visually sensible indicia.

16. A system for travel planning according to claim 12 and wherein said at least one desired travel parameter comprises a type of user activity.

17. A system for travel planning according to claim 12 and wherein said at least one desired travel parameter comprises a type of user interest.

18. A system for travel planning according to claim 16 and wherein said geographical boundaries of said at least one proposed travel region are selected at least partially by the extent of presence within said geographical boundaries of user selectable proposed travel locations.

19. A system for travel planning according to claim 12 and wherein said at least one proposed travel region has geographical boundaries which are determined by said interactive computer system at least in part by said at least one desired travel parameter designated by said user.

20. A system for travel planning according to claim 19 and wherein said at least one desired travel parameter is selected by said user from a prepared set of possible desired travel parameters available for designation by said user.

21. A system for travel planning according to claim 20 and wherein said geographical boundaries of said at least one proposed travel region are pre-determined for plural ones of said possible desired travel parameters available for designation by said user.

22. A system for travel planning according to claim 19 and wherein said geographical boundaries of said at least one proposed travel region are generated by said interactive computer system in response to designation of said at least one desired travel parameter by said user.

23. A method for constructing a system for travel planning including:
a graphical user interface operative to enable user designation of at least one desired travel parameter;
an interactive computer system responsive to said user designation for selecting at least one proposed travel region; and
a display presenting to said user in visually sensible form said at least one proposed travel region,
the method comprising:
designating a plurality of desired travel parameters;
for said plurality of desired travel parameters, selecting a multiplicity of proposed travel locations corresponding thereto;
selecting geographical boundaries of said at least one proposed travel region independently of political boundaries; and
preparing information relating at least one of said at least one proposed travel region for presentation to said user on said display in visually sensible form.

24. A method for constructing a system for travel planning according to claim 23 and also comprising:
preparing information relating at least to a visually sensible graphical map of said at least one proposed travel region bearing visually sensible indicia corresponding to proposed travel locations within said at least one proposed travel region corresponding to said at least one desired travel parameter for presentation to said user on said display in visually sensible form.

25. A method for constructing a system for travel planning according to claim 24 and also comprising:
configuring said graphical user interface for user designation of user-selected ones of said visually sensible indicia; and
configuring said interactive computer system for collection of travel locations corresponding to said user-selected ones of said visually sensible indicia.

26. A method for constructing a system for travel planning according to claim 25 and also comprising:
configuring said interactive computer system for generation of a proposed travel itinerary based at least partially on said user-selected ones of said visually sensible indicia.

27. A method for constructing a system for travel planning according to claim 23 and wherein said at least one desired travel parameter comprises a type of user activity.

28. A method for constructing a system for travel planning according to claim 23 and wherein said at least one desired travel parameter comprises a type of user interest.

29. A method for constructing a system for travel planning according to claim 27 and wherein said selecting said geographical boundaries of said at least one proposed travel region includes selection of said geographical boundaries at least partially by the extent of presence within said geographical boundaries of user selectable proposed travel locations.

30. A method for constructing a system for travel planning according to claim 27 and wherein said selecting said geographical boundaries of said at least one proposed travel region includes constructing an interactive functionality operative to enable automatic selection of said geographical boundaries at least partially in accordance with the extent of presence within said geographical boundaries of proposed travel locations corresponding to said at least one desired travel parameter designated by said user.

31. A method for constructing a system for travel planning according to claim 30 and wherein said interactive functionality enables said at least one desired travel parameter to be selected by said user from a prepared set of possible desired travel parameters available for designation by said user.

32. A method for constructing a system for travel planning according to claim 31 and wherein said interactive functionality employs pre-determined geographical boundaries of said at least one proposed travel region corresponding to plural ones of said possible desired travel parameters available for designation by said user.

33. A method for constructing a system for travel planning according to claim 30 and wherein said interactive functionality enables said geographical boundaries of said at least one proposed travel region to be generated in response to designation of said at least one desired travel parameter by said user.
